(19) United States
(12) Patent Application Publication
(10) Pub. No.: US 2013/0213021 A1
(43) Pub. Date: Aug. 22, 2013

(54) MONREALPOWER

(71) Applicant: RENATO L. MONREAL, Houston, TX (US)

(72) Inventor: RENATO L. MONREAL, Houston, TX (US)

(21) Appl. No.: 13/337,107

(22) Filed: Feb. 21, 2012

(51) Int. Cl. F03G 7/00

(52) U.S. Cl. CPC F03G 7/00
USPC 60/325

(57) ABSTRACT

MONREALPOWER is a mechanical design to power up a turbine/generator to generate electricity or power up car engine and alike without using any gasoline or related fuel. Power will be generated using the combination of air pressure and plain “clean water” as the driving force. A revolutionary design in Mechanical and Electrical Engineering using cheap and almost unlimited source.

MONREALPOWER is the concept of the future machine or engine powered by “water cannon”, which is the opposite concept of modern day machine or engine which is powered by “fire cannon”.

### CROSS REFERENCE TO RELATED APPLICATIONS

There are no related applications to cross reference this invention. This section is “Not Applicable”.

### STATEMENT REGARDING FEDERALLY SPONSORED RESEARCH OR DEVELOPMENT

Research and development of “MONREALPOWER” is not federally sponsored.

### REFERENCE TO SEQUENCE LISTING, A TABLE, OR A COMPUTER PROGRAM LISTING COMPACT DISC APPENDIX

There are no materials submitted separately with this invention. This section is “Not Applicable”.

### BACKGROUND OF INVENTION

This invention pertains to the combination of water and air pressure as the driving force to generate electricity or power up car engine and alike which will revolutionize mechanical and electrical engineering using cheap and unlimited source.

### BRIEF SUMMARY OF INVENTION

A mechanical design to power up a turbine/generator to generate electricity or power up car engine and alike without using any gasoline or related fuel. Power will be generated using plain “clean water”.

### BRIEF DESCRIPTION OF THE SEVERAL VIEWS OF THE DRAWING

FIG. 1—PLAN VIEW—Drawing showing the top view arrangement and the process of infinite cycle of how the energy will be generated using air and water pressure.

FIG. 2—SECTION A-A—Drawing showing a sectional view of the varying elevation and arrangement of parts.

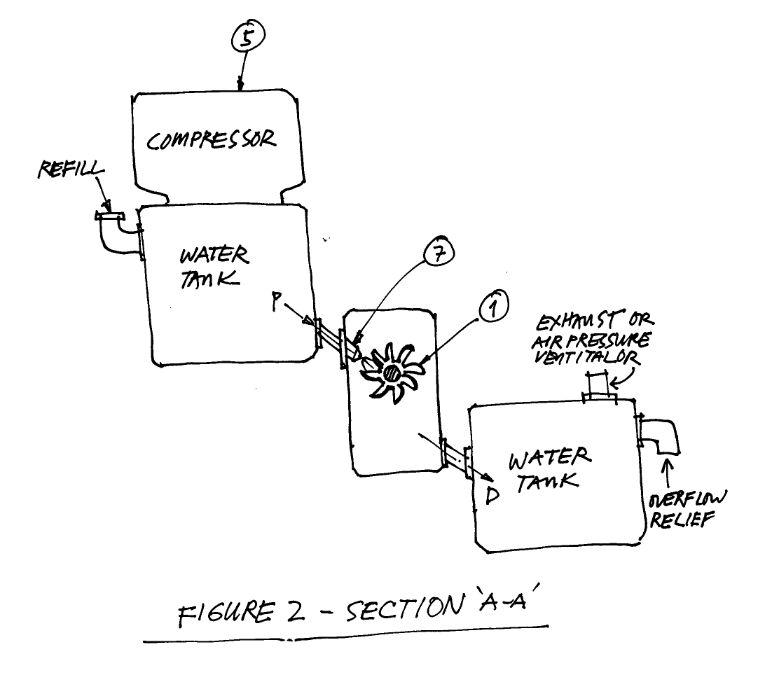

### DETAILED DESCRIPTION OF THE INVENTION

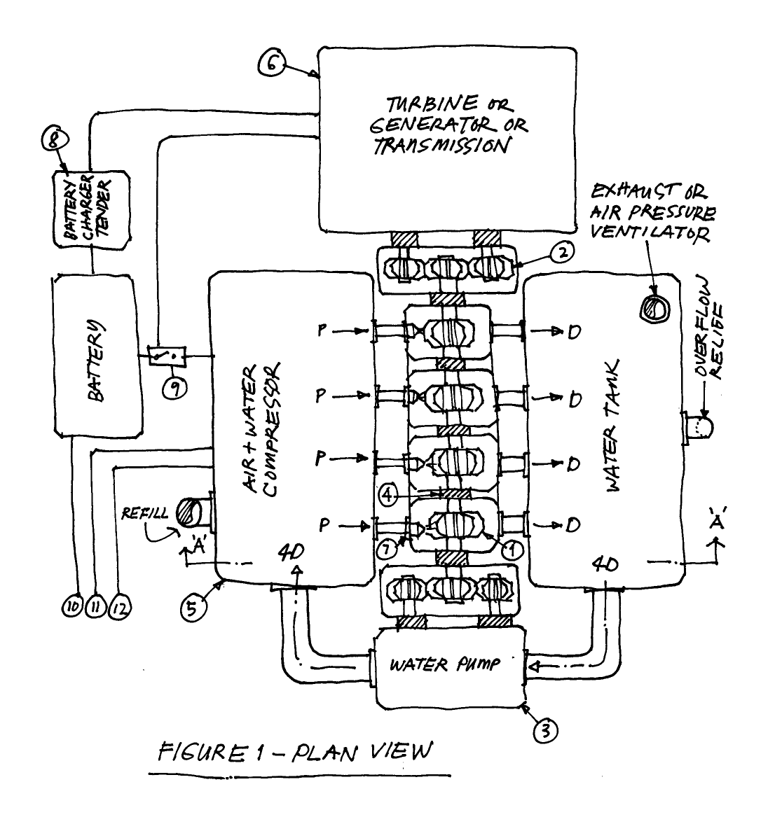

Refer FIG. 1—PLAN VIEW for design concepts labeled by numbers 1 to 12.

(1) SPOON-LIKE PROPELLERS

Design spoon-like propellers to rotate in one direction to ensure continuous flow and generation of energy.

(2) MULTIPLE GEARS

Design multiple gears from smallest to largest so that small amount of force can grow exponentially.

(3) WATER PUMP

Design water pump to pumped water back to the compressor tank the same amount of water discharged (D) to generate an almost infinite cycle.

(4) BEARINGS

Design bearings to be frictionless so that small amount of force (P) will make the gear to rotate.

(5) AIR+WATER COMPRESSOR

Design air and water compressor to start using power from the battery then switch power source from generator or turbine when enough energy is generated to sustain power needed by air+water compressor.

(6) TURBINE/GENERATOR/TRANSMISSION

Design turbine or generator to generate electricity like hydro-power plant and transmission to propel car or automobile.

(7) WATER CANNON

Design water cannon to be controlled by selector switch for turbine and generator and accelerator pedal for car or automobile generate varying speed or pressure.

(8) BATTERY CHARGER/TENDER

Design battery charger to recharge battery pack then keep in “Maintain” level once battery is fully charged.

(9) SWITCH

Design switch to turn off power from battery when compressor is running using turbine or generator as power source.

(10) BATTERY PACK

Design battery pack to power up air+water compressor.

(11) WATER LEVEL GAUGE

Design water level gauge to determine the amount of water to refill.

(12) AIR PRESSURE GAUGE

1. I, Renato Llandelar Monreal, claim as the first and sole inventor of “MONREALPOWER” and that this is my own original concept and idea. I claim to be protected by all applicable laws that my invention shall not be used or copied in whole or in part without my written authorization.
